(19) United States
(12) Patent Application Publication
(10) Pub. No.: US 2025/0078676 A1
(43) Pub. Date: Mar. 6, 2025

(54) Deep Learning-Based Natural Language Understanding Method and AI Teaching Assistant System

(71) Applicant: AristAI Inc., Chicago, IL (US)

(72) Inventors: Qingquan Zhang, Palatine, IL (US); Jiheng Jing, Chicago, IL (US); Ruiqing Yu, Chicago, IL (US); Qitao Xie, Chicago, IL (US); Kexin Kang, Chicago, IL (US)

(21) Appl. No.: 18/792,382

(22) Filed: Aug. 1, 2024

(30) Foreign Application Priority Data
Aug. 4, 2023 (CN) 202310978221.5

(51) Int. Cl. G09B 5/06; G06N 5/022; G06N 5/04

(52) U.S. Cl. CPC G09B 5/065; G06N 5/022; G06N 5/04

(57) ABSTRACT

The present invention provides a deep learning-based natural language understanding method and an intelligent teaching assistant system. First, it involves constructing a knowledge database and a question database, where learning material documents are saved into the knowledge database and preprocessed natural language information is saved into the question database. The method then involves learning and understanding the natural language information in the question database, searching for related knowledge points in the knowledge database based on the understood content, selecting the best-matched learning materials corresponding to these knowledge points as samples to respond to the natural language information, and generating a record that includes the question, response, and evaluation, which is saved into the knowledge database. Finally, it generates multiple forms of responses and outputs them according to the corresponding requirements.

### FIELD OF THE INVENTION

The present invention relates to the technical field of intelligent teaching assistant systems, and in particular, to methods and intelligent teaching assistant systems based on natural language understanding using deep learning.

### BACKGROUND OF THE INVENTION

With the advancement of artificial intelligence technology, many intelligent teaching assistant systems have emerged. However, most of these systems are limited to pre-programmed responses and do not support free-form conversation with users. Some conventional systems employ natural language processing algorithms such as Long Short-Term Memory (LSTM) networks and Convolutional Neural Networks (CNNs), but these algorithms require extensive new data and considerable training time, which limits their efficiency and potential.

Existing intelligent teaching assistant systems often struggle with processing efficiency due to the large amount of data needed for training. Furthermore, the computational resources required can be substantial, leading to performance bottlenecks. These systems also lack interactive and immersive experiences, providing only limited response formats and failing to engage users effectively.

Therefore, there is an urgent need for a method that can improve the efficiency and accuracy of natural language understanding, while reducing the demand for computational resources. This invention aims to address these challenges by providing a deep learning-based natural language understanding method and an AI teaching assistant system that could enhance user interaction, support multiple media formats, and operate efficiently in real-time.

### SUMMARY OF THE INVENTION

To address the technical issues described above, the present invention provides a natural language understanding method based on deep learning, which solves the problems of requiring large amounts of data and low efficiency in existing training algorithms.

To achieve the foregoing objective, the technical solution of the present invention is described as follows:

One aspect of the present invention provides a natural language understanding method based on deep learning. The method may include the following steps:
1. Constructing a knowledge database: First, obtaining various forms of pre-stored or user-uploaded learning materials, cleaning and preprocessing these learning materials, then organizing and summarizing the cleaned and preprocessed learning materials into documents, and saving them into the knowledge database;
2. Constructing a question database: Preprocessing various forms of natural language information input by users, then saving the preprocessed natural language information into the question database;
3. Learning and understanding the natural language information in the question database, searching for related knowledge points in the knowledge database based on the understood content, and using one or more scoring or matching algorithms to select the best-matched learning materials corresponding to the knowledge points to reply to the natural language information;
4. Generating a record that includes the question, the reply, and the evaluation, and saving it into the knowledge database;
5. Generating multiple forms of replies and outputting them according to corresponding needs.

In some embodiments, the learning materials, user input natural language information, and replies each include but are not limited to at least one of text, audio, video, and images. In step 1, the cleaning and preprocessing of learning materials may include but are not limited to:
filtering valid information: identifying and removing invalid, redundant, or irrelevant information from the learning materials, retaining only information that contributes to understanding the text content;
recording and understanding knowledge points: recording and understanding several knowledge points and their inherent relationships within the learning materials;
marking knowledge categories: analyzing the content of the learning materials to identify and mark the knowledge categories covered;
preprocessing video and audio learning materials: generating subtitles for video and audio materials, and performing preprocessing such as semantic-based segmentation, timestamp marking, and speaker identification;
preprocessing image learning materials: identifying and extracting text, object features, visual elements, and various parameter information from images, converting this information into textual descriptions, and processing the textual descriptions;
standardization: standardizing the learning materials to reduce data noise;
removing noise information: identifying and removing noise information, including but not limited to grammatical errors, typos, and irrelevant words.

In some embodiments, in step 2, the preprocessing of natural language information includes but is not limited to:
marking categories of natural language information: analyzing the content of user input natural language information to identify and mark the knowledge categories covered;
preprocessing video and audio natural language information: generating subtitles for video and audio information, and performing preprocessing such as semantic-based segmentation, timestamp marking, and speaker identification;
preprocessing image natural language information: identifying and extracting text, object features, visual elements, and various parameter information from images, converting this information into textual descriptions, and processing the textual descriptions;
standardization: standardizing the textual information generated from natural language information to reduce data noise;
removing noise information: identifying and removing noise information, including but not limited to grammatical errors, typos, and irrelevant words.

In some embodiments, in step 3, learning and understanding the natural language information in the question database includes but is not limited to:
extracting key points: using AI large language models to learn and extract several key points from the natural language information;
understanding key points: using natural language processing models to understand and record each key point.

In some embodiments, in step 3, selecting the best-matched learning materials corresponding to the knowledge points to reply to the natural language information includes but is not limited to:
searching for related learning materials: comparing the key points in the natural language information with the knowledge points in the knowledge database, and finding several knowledge points that are closest to the key points in the vector space;
selecting the best-matched learning materials: comparing the found learning materials with the key points in the natural language information, and selecting the best-matched learning materials;
replying using the learning materials: using the selected best-matched learning materials, in conjunction with a trained AI large language model, to reply to the natural language information.

In some embodiments, in step 4, a self-learning scoring process is also included, which may specifically include:
collecting and recording user feedback on the replies, including positive and negative feedback;
scoring the replies based on the collected feedback using certain scoring rules;
using the scoring results to optimize the replies, including but not limited to adjusting parameter weights, re-understanding the key points of the instructions, and regenerating more detailed and accurate replies.

In some embodiments, in step 5, the replies include but are not limited to the following forms:
if it is text, directly outputting to the terminal;
if it is audio, converting text to speech and synchronously outputting as audio;
if it is learning materials, including but not limited to knowledge graphs and slides, using an embedded image generator to generate relevant output contents as needed;
if it is a video, outputting a video link or playing the video in an embedded window.

To further solve the problems of lack of interactivity and immersion with intelligent teaching assistants, and the single form of replies in existing intelligent teaching assistant systems, another aspect of the present invention also provides an AI teaching assistant system, with the specific technical solution as follows: An AI teaching assistant system includes a cloud backend and a user terminal. The user terminal collects various command questions and evaluation information on replies input by users, and transmits them to the cloud backend. The cloud backend processes the command questions using the aforementioned natural language understanding method based on deep learning and feeds back the reply information to the user terminal. The user terminal allows users to evaluate the replies and provide feedback based on the received reply information.

In some embodiments, the cloud backend includes a knowledge base storage module, a question input module, a backend learning module, a self-learning scoring module, and a knowledge output module, wherein:
the knowledge base storage module is used to store the knowledge database;
the question input module is used to receive natural language information from the user terminal, including but not limited to text, audio, video, and images, and preprocess the received natural language information;
the backend learning module is used to learn and understand the natural language information input by users and generate multiple forms of replies;
the self-learning scoring module is used to assign weights to the backend learning module, optimize the backend learning module and its replies;
the knowledge output module is used to output the replies generated by the backend learning module to the user terminal.

In some embodiments, the user terminal is any hardware carrier with a user interaction interface and various forms of reply output modules. The user terminal may support user-uploaded learning materials in various forms, including but not limited to text, audio, video, and images, which the cloud backend stores in the knowledge database via the knowledge base storage module.

A further aspect of the present invention provides a computer storage medium, characterized by storing several computer instructions, which, when invoked, execute all or part of the steps of the aforementioned natural language understanding method based on deep learning.

Compared with the prior art, the present invention has at least the following beneficial effects:
1. By using multiple deep learning natural language processing algorithms, it solves the problems of requiring large amounts of data and low efficiency in training algorithms, thereby saving computational resources and improving efficiency.
2. By placing the algorithm learning and computation in the cloud, it solves the issues of server overload and untimely response caused by multiple processes, thereby achieving real-time use by multiple users without mutual interference.
3. By accepting questions in various media, generating natural language processing replies, and replying in multiple media formats, it solves the problems of high costs, insufficient manpower, and low efficiency of human teaching assistants, as well as the single reply format and pre-programmed questions in traditional intelligent teaching assistants, achieving comprehensive and diverse answers that are easy to understand regardless of the question format (text, audio, or screenshot).
4. By incorporating Web3.0 technology, it allows the AI teaching assistant system to connect to the VR metaverse, solving the lack of interactivity and immersion with intelligent teaching assistants, thereby enhancing the practicality of user interaction and the efficiency of information delivery.

Other features and advantages of the present invention will be further described in the subsequent specification and partially become apparent from the specification or be understood by implementing the present invention. An objective and other advantages of the present invention are achieved and obtained in structures that are specifically pointed out in the specification and the accompanying drawings.

To make the foregoing objectives, features, and advantages of the present invention easier to understand, a detailed description is made below using listed exemplary embodiments with reference to the accompanying drawings.

### BRIEF DESCRIPTION OF THE FIGURES

To more clearly describe the technical solutions in the embodiments of the present invention or in the prior art, the following will briefly introduce the drawings required for describing the embodiments or the prior art. It is apparent that the drawings in the following description are only some embodiments described in the present invention, and a person of ordinary skill in the art may obtain other drawings on the basis of these drawings without any creative effort.

FIG. 1 is a schematic diagram of the functional modules of the teaching assistant system according to one embodiment of the present invention.

FIG. 2 is a schematic flowchart of the sample acquisition method according to one embodiment of the present invention.

FIG. 3 is a schematic flowchart of the self-learning module method according to one embodiment of the present invention.

### DETAILED DESCRIPTION OF THE INVENTION

To make the objectives, technical solutions, and advantages of the present invention clearer and more comprehensible, the following further describes the present invention in detail with reference to the accompanying drawings and embodiments. It should be understood that the specific embodiments described herein are merely used to explain the present invention but are not intended to limit the present invention.

The natural language understanding method based on deep learning according to the present invention may include the following steps:
1. Constructing a knowledge database: first, obtaining various forms of pre-stored or user-uploaded learning materials, cleaning and preprocessing these learning materials, then organizing and summarizing the cleaned and preprocessed learning materials into documents, and saving them into the knowledge database;
2. Constructing a question database: preprocessing various forms of natural language information input by users, then saving the preprocessed natural language information into the question database;
3. Learning and understanding the natural language information in the question database, searching for related knowledge points in the knowledge database based on the understood content, and using one or more scoring or matching algorithms to select the best-matched learning materials corresponding to the knowledge points to reply to the natural language information;
4. Generating a record that includes the question, the reply, and the evaluation, and saving it into the knowledge database;
5. Generating multiple forms of replies and outputting them according to corresponding needs.

Related learning materials may be searched by using word embedding technology, which maps text content into a vector space and calculates the similarity between text vectors.

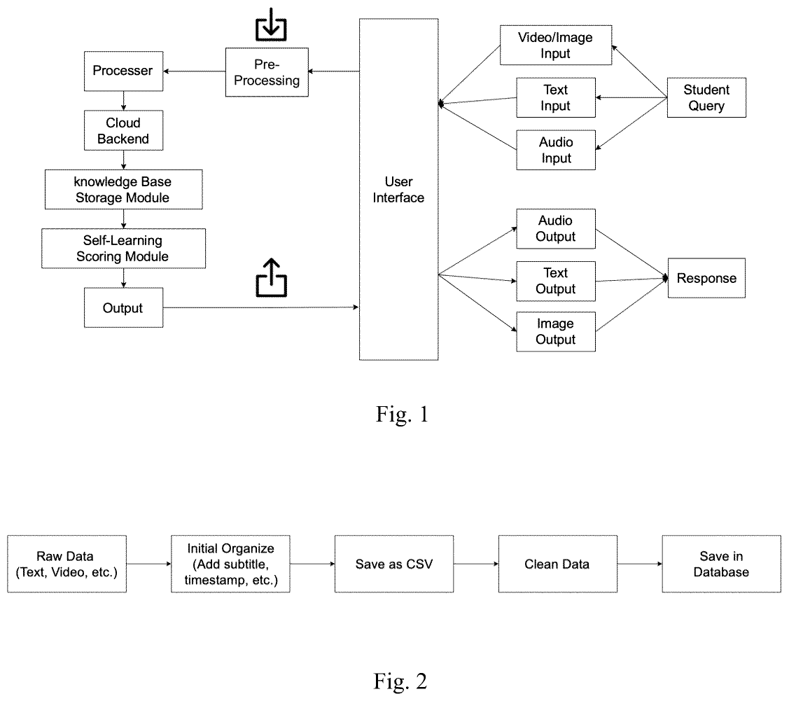

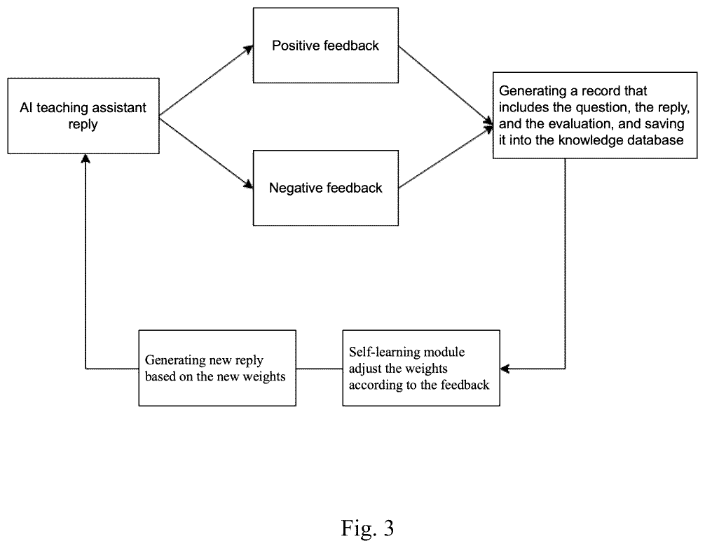

More specifically, as shown in FIGS. 1 to 3, the natural language understanding method based on deep learning includes the following steps.

Step 1 is constructing a knowledge database: obtaining various forms of pre-stored or user-uploaded learning materials, including but not limited to text, audio, video, and images. In some embodiments, cleaning and preprocessing these learning materials may involve several stages, including:
(a) filtering valid information: identifying and removing invalid, redundant, or irrelevant information from the learning materials, ensuring that only information contributing to understanding the text content is retained. Specifically, the information that contributes is meaningful information, determined by its contribution score. The specific determination methods include, but are not limited to, using word embedding techniques to map text content into a vector space and identifying information that is closer in distance to the overall text content in the vector space, meaning it is more relevant. This ensures that only information contributing to the understanding of the text content is retained in the process of filtering valid information;
(b) recording and understanding knowledge points: using one or more natural language processing techniques, including word embedding, to record and understand several knowledge points and their inherent relationships within the learning materials. Here, word embedding is a technique that maps words or phrases from a vocabulary into a vector space, capturing the semantic and syntactic relationships of the words. This ensures that words with similar meanings are closer together in the vector space;
(c) marking knowledge categories: analyzing the content of the learning materials to identify and mark the knowledge categories covered;
(d) preprocessing video and audio learning materials: generating subtitles using one or more speech recognition techniques, and preprocessing the subtitle content, including semantic-based segmentation, timestamp marking, and speaker identification;
(e) preprocessing image learning materials: using one or more image recognition techniques to identify and extract important information from images, such as text, object features, visual elements, and various parameters, converting this information into textual descriptions, and processing these textual descriptions further;
(f) standardization: standardizing the learning materials includes, but is not limited to, converting English characters to lowercase, converting Chinese characters to simplified, and removing special symbols to reduce data noise and complexity;
(g) removing noise information: identifying and removing other noise information, including grammatical errors, typos, and irrelevant words.

Step 2 is preprocessing various forms of natural language information input by users, including but not limited to text, audio, video, and images. This preprocessing may include:
(a) marking categories of natural language information: analyzing the content of user input natural language information to identify and mark the knowledge categories covered;
(b) preprocessing video and audio natural language information: generating subtitles using one or more speech recognition techniques, and preprocessing the subtitle content, including semantic-based segmentation, timestamp marking, and speaker identification;
(c) preprocessing image natural language information: using one or more image recognition techniques to identify and extract important information from images, converting this information into textual descriptions, and processing these textual descriptions further;
(d) standardization: standardizing the learning materials which includes, but is not limited to, converting English characters to lowercase, converting Chinese characters to simplified, and removing special symbols to reduce data noise and complexity;
(e) removing noise information: identifying and removing other noise information, including grammatical errors, typos, and irrelevant words;
(f) removing noise information: identifying and removing other noise information, including grammatical errors, typos, and irrelevant words,

Then, the preprocessed natural language information is saved into the question database.

Step 3 is learning and understanding the natural language information in the question database, which may include:
(a) extracting key points: using one or more AI large language models, such as GPT, to learn and extract several key points from the natural language information;
(b) understanding key points: using one or more natural language processing techniques, including word embedding, to understand and record each key point.

This may further include, based on the understood content, searching for related knowledge points in the knowledge database, and using one or more scoring or matching algorithms to select the best-matched learning materials corresponding to the knowledge points to reply to the natural language information. In some embodiments, this includes:
(a) searching for related learning materials: comparing the key points in the natural language information with the knowledge points in the knowledge database using one or more algorithms, such as cosine similarity, to find several knowledge points that are closest to the key points in the vector space. The cosine similarity algorithm is a measure used to calculate the cosine of the angle between two vectors, commonly used to assess the similarity between two vectors. The mathematical formula in its common form is: cos(θ)=(A·B)/(∥A∥∥B∥). Here, θ is the angle between the two vectors, A·B is the dot product of vectors A and B, and ∥A∥ and ∥B∥ are the magnitudes (norms) of vectors A and B, respectively.
(b) selecting the best-matched learning materials: comparing the found learning materials with the key points in the natural language information using one or more algorithms, including AI large language models, to select the best-matched learning materials;
(c) replying using the learning materials: using one or more algorithms, including but not limited to few-shot learning, the system responds to the natural language information based on the selected best-matched learning materials and the trained AI large language model. Few-shot learning refers to a machine learning technique that, even with a small number of training samples, can still make accurate predictions by leveraging pre-trained AI large language models.

Step 4 is generating a record that includes the question, the reply, and the evaluation, and saving it into the knowledge database. This step also includes a self-learning scoring process, as follows:
(a) collecting feedback: collecting and recording user feedback on the replies, including positive and negative feedback;
(b) scoring calculation: scoring the replies based on the collected feedback using certain scoring algorithms;
(c) feedback application: using the scoring results to optimize the replies, including adjusting parameter weights, re-understanding the key points of the instructions, and regenerating more detailed and accurate replies.

Step 5 is generating multiple forms of replies, including but not limited to text, audio, video, and images, and outputting them according to corresponding needs. This may include:
(a) if it is text, directly outputting to the terminal;
(b) if it is audio, converting text to speech and synchronously outputting as audio;
(c) if it is learning materials, including but not limited to knowledge graphs and slides, generating relevant materials as needed using an embedded image generator;
(d) if it is a video, outputting a video link or playing the video in a small window.

In another aspect, the AI teaching assistant system according to the present invention includes a cloud backend and a user terminal. The user terminal collects various command questions and evaluation information on replies input by users and transmits them to the cloud backend. The cloud backend processes the command questions using the aforementioned natural language understanding method based on deep learning and feeds back the reply information to the user terminal. The user terminal allows users to evaluate the replies and provide feedback based on the received reply information.

In some embodiments, the cloud backend includes a knowledge base storage module, a question input module, a backend learning module, a self-learning scoring module, and a knowledge output module, as further descried below.

Knowledge Base Storage Module: In some embodiments, this module is used to store learning materials from online learning platforms or school courses. These learning materials can be in the form of text, images, videos, etc., with a particular focus on recorded videos from online learning platforms. These materials will go through a series of cleaning and preprocessing steps, including but not limited to filtering valid information, recording knowledge point keywords, marking the knowledge categories covered by images and videos, generating subtitles for videos and marking timestamps, extracting text from images, and more. The next step is to organize all data into documents and save them into the database. Data can be stored according to knowledge categories, but a more practical approach is to store it based on the uploading institution and school. This ensures that the responses users receive are related to their affiliated institution or school;

Question Input Module: In some embodiments, this module is used to receive natural language information sent from the user terminal, including but not limited to text, audio, video, and images, and to preprocess the received natural language information. For example, it collects and records questions posed by student users to the assistant or instructions given by teacher users to the assistant. The format of the instructions is not fixed and can include text, audio, video, and images. Text instructions will directly enter the preprocessing stage, while audio instructions will be converted into text using speech recognition. The assistant will identify and extract text information from uploaded images and send it to the preprocessing stage. Videos will be split into audio and image information for separate processing. During preprocessing, the assistant will identify valid instructions and other noise information. Valid instructions will be sent to the backend learning module;

Backend Learning Module: In some embodiments, this module is used to learn and understand the natural language information input by users and generate multiple forms of responses. For example, it learns and understands the aforementioned string sequences and searches for related knowledge points in the knowledge database based on the understanding. The backend learning module includes two well-established deep learning natural language understanding algorithms: GPT-3 and BERT. The BERT algorithm can learn instructions bidirectionally and capture keywords. It can also process multiple lines of instructions simultaneously, learning and understanding the key points and functions of each line, and selecting the most appropriate response. GPT-3 uses few-shot learning, consuming fewer resources to learn user instructions. GPT-3 also assigns weights to each possible response and sends them back to the self-learning scoring module;

Self-Learning Scoring Module: In some embodiments, this module is used to assign weights to the backend learning module and optimize the backend learning module and its responses. It assigns weights to the responses generated by the backend learning module. The module uses ensemble learning to integrate the results of the two language processing algorithms into several classifiers. Each classifier uses a linear model to fit instructions and responses, and then returns the result with the smallest mean variance. Ensemble learning summarizes the results of all classifiers and selects the most likely result to be transmitted to the text and audio output modules. Additionally, the frontend is equipped with a rating system, allowing users to evaluate each response from the assistant. Whether the feedback is positive or negative, the results are sent back to the self-learning scoring module for self-optimization. Optimization includes adjusting parameter weights, re-understanding the key points of user questions, and regenerating more detailed responses. A record, containing the user's question, the assistant's generated response, and the user's evaluation, is generated and saved in the storage module;

Knowledge Output Module: In some embodiments, this module is used to output the responses generated by the backend learning module to the user terminal. For example, it conveys the content generated by the assistant to the user. The assistant can generate responses in various forms, including text, audio, images, and videos. The text responses are directly transmitted back to the interaction interface. Audio responses are synchronously output using a text-to-speech service. In some cases, such as when the user requests the generation of a knowledge tree or knowledge graph, the embedded image generator can create the relevant images based on the user's needs. The assistant can also provide hyperlinks or play a video clip in a small window. This video clip can address the user's question and is easier to understand than plain text. The video can be a recorded lecture or an online learning platform course video;

In some embodiments, the user terminal is any hardware carrier with a user interaction interface and various forms of reply output modules. The user terminal supports user-uploaded learning materials in various forms, including but not limited to text, audio, video, and images, which the cloud backend stores in the knowledge database via the knowledge base storage module.

To further explain the solution, the following example provides a detailed description of the specific implementation process:
1. Cleaning and preprocessing the pre-collected learning materials, specifically (using video learning materials as an example):
   1.1. Using one or more speech recognition techniques, generating subtitles from the video learning materials, and recording the start and end timestamps of each word, as well as marking the sound source;
   1.2. Using pre-trained AI large language models, segmenting the subtitles by sentences, and removing noise information (such as grammatical errors, typos, irrelevant words, etc.);
   1.3. Using natural language processing techniques, standardizing each complete sentence (including but not limited to converting English characters to lowercase, converting Chinese characters to simplified, removing special symbols, etc.) and filtering valid information (including but not limited to removing irrelevant words, duplicate sentences, etc.);
   1.4. Based on the records from step 1.1, adding start and end timestamps to each cleaned complete sentence, and marking the sound source, including but not limited to video name, author, creation date, video address, video cover, and corresponding course information; combining all subtitles of the video learning materials into a complete text, and summarizing and summarizing its content using AI large language models;
   1.5. Using one or more word embedding models, mapping each complete sentence into different vector spaces, and recording all vector information of each complete sentence;
   1.6. Organizing and summarizing the cleaned and preprocessed learning materials according to the related information of knowledge categories, forming documents, and saving these documents into the knowledge database.
2. User selects course information (example: user selects a knowledge category included in a specific knowledge database, such as English teaching);
3. User inputs natural language information (example: What are the key points of Expression and Majority? Please summarize the content of the video “Day 3”. Reply in list form);
4. Preprocessing the “user input natural language information” using the question input module, which includes:
   4.1. Using natural language processing techniques, standardizing the “user input natural language information” (including but not limited to converting English characters to lowercase, converting Chinese characters to simplified, removing special symbols) and removing noise information (including but not limited to grammatical errors, typos, irrelevant words, etc.);
   4.2. Matching and identifying the knowledge category corresponding to the “user input natural language information” based on the course information selected by the user in step 2.
5. Learning, understanding, analyzing, and generating multiple forms of replies to the “user input natural language information” using the backend learning module, including:
   5.1. Using pre-trained AI large language models to determine, separate, and store the “question” and “requirements for the reply” in the “user input natural language information”; (example: “Question”: What are the key points of Expression and Majority? Please summarize the content of the video “Day 3”. “Requirements for the reply”: Reply in list form.)
   5.2. Using pre-trained AI large language models to learn, understand, and analyze the “question” part, and then split it into several “independent questions”; (example: “Independent questions”: 1. What are the key points of Expression? 2. What are the key points of Majority? 3. What is the content of the video “Day 3”?)
   5.3. Using pre-trained AI large language models to learn, understand, and analyze each “independent question” to determine its type, including but not limited to “questions about specific knowledge points” or “summary questions about a learning material,” and selecting the best-matched learning material type based on this determination; (example: “Questions about specific knowledge points”: 1. What are the key points of Expression? 2. What are the key points of Majority?; “Summary questions about a learning material”: 1. What is the content of the video “Day 3”?)
   5.4. Generating replies to each “independent question” if it is a “question about specific knowledge points” using the following steps:
      5.4.1. Using one or more word embedding models to map the “independent question” into the corresponding vector space; (example: using several word embedding models in the Python framework of Sentence Transformers)
      5.4.2. Using cosine similarity algorithms to compare the “independent question” with each knowledge point in the knowledge database. Using one or more evaluation criteria, selecting several knowledge points that are closest to the “independent question” in each evaluation criterion, and recording; (example: calculating the distance between each sentence in the learning materials and the “independent question” using the cosine similarity algorithm, selecting the closest sentences in each model, and recording their positions in the learning materials. Calculating the distance between each sentence in the learning materials and the “independent question” using the cosine similarity algorithm, selecting the closest sentences in each model, and recording their positions in the learning materials.)
      5.4.3. Using pre-trained AI large language models to compare all recorded knowledge points and their partial content in the learning materials with the “independent question,” and selecting one or more best-matched learning materials; (example: merging several sentences near the positions of all recorded knowledge points as a sample paragraph, and comparing all sample paragraphs with the “independent question” using AI large language models, selecting one or more best-matched sample paragraphs.)
      5.4.4. Using few-shot learning and pre-trained AI large language models, generating replies to the “independent question” based on the best-matched learning materials combined with the “requirements for the reply” in step 5.1; (example: using the best-matched sample paragraphs selected in step 5.4.3 as samples to train AI large language models and generating replies to the “independent question” based on these sample paragraphs.)
   5.5. If the “independent question” is a “summary question about a learning material,” the following steps are used to generate a response to the “independent question”:
      5.5.1. Use one or more word embedding models to map the “independent question” into the corresponding vector space. (Example: using several word embedding models in the Python framework of Sentence Transformers);
      5.5.2. Use the cosine similarity algorithm to compare the “independent question” with each learning material in the knowledge database. Using one or more evaluation criteria, select the learning materials that are closest to the “independent question” in each evaluation criterion, and record them. (Example: calculate the distance between the information related to the knowledge categories of the learning materials, including but not limited to video name, author, creation date, video address, video cover, corresponding course, etc., and the “independent question” using the cosine similarity algorithm, and select and record the top few learning materials in each model that are closest to the “independent question.”);
      5.5.3. Use pre-trained AI large language models to compare all the learning materials recorded in Step 5.5.2 and their related information with the “independent question,” and select one or more best-matched learning materials. (Example: based on the information related to the knowledge categories recorded in Step 5.5.2, use AI large language models to compare the information related to the knowledge categories with the “independent question” and select one or more best-matched learning materials. For a “summary question about a learning material”: What is the content of video “Day 3”? The final best-matched learning material would be the video named “Day 3.”);
      5.5.4. Use few-shot learning and pre-trained AI large language models to generate a response to the “independent question” based on the best-matched learning materials and their pre-summarized content, combined with the “requirements for the reply” from Step 2.1. (Example: use the pre-summarized content of the best-matched learning materials selected in Step 5.5.3 as samples to train AI large language models, and generate a response to the “independent question” based on these sample paragraphs.)
   5.6. Integrating all generated replies and generating a complete reply, including:
      5.6.1. Combining the best-matched learning materials and related information of each “independent question,” including video timestamps, video links, video authors, creation dates, etc., with the replies generated in step 5.5 into a complete reply; (example: Key points of Expression:
         1. Meaning of expression;
         2. Meaning of expression in democracy;
         3. Specific manifestation, translated as “of”;
         4. Adjective: expressive, meaning richly expressive;
         5. Adjective: expressible, meaning able to express clearly;
         6. Negative adjective: inexpressible, meaning unable to be expressed in words.
         This answer is based on the video “Day 3”.
         Key points of Majority:
         1) Majority: the most, often used to describe the proportion of quantity or people.
         2) Minority: minority, corresponding to the majority.
         3) A majority of: the most, often used to modify nouns.
         4) Take something seriously: take something seriously, often used to express attitudes or behaviors.
         5) It is obvious that: obviously, often used to introduce an obvious view or conclusion.
         6) System/Systematic: system/systematic, often used to describe some kind of system or method.
         7) Warning System: warning system, often used to describe some kind of warning mechanism.
         8) Red Alert: red alert, often used to indicate the highest level of danger.
         9) Endangered Species: endangered species, often used to describe the protection of biodiversity.
         10) Systematic Survey Methods: systematic survey methods, often used to describe scientific research methods.
         11) Systematic drug abuse: systematic drug abuse, often used to describe the scale and impact of drug abuse.
         This answer is based on the video “Day 2”.
         Introduced words related to value, such as value, evaluate, valuable, etc.
         Discussed the concept of the best education method and school district housing.
         Described common prefixes in English and words related to value, work, production, etc.
         Explained the concepts of depreciation and underestimation, and their differences, as well as the subjectivity and quantification methods of value.
         Talked about the dedication spirit of scientific careers and the reflection of personal choices, and some related words, such as overvalue, toxic assets, etc.
         Introduced words and collocations related to head, and words related to titles, emphasizing the simple rules of verbs modifying nouns.
         Explained several words related to economics and finance, such as clickbait, headlong, overhead, finance, and financial.
         Introduced some words related to finance and technology, such as financial, fiscal, technology, high technology, and technological.
         Described words and expressions related to consumption and shopping in English, such as “consumed sparingly”, “consuming”, “style conscious consumers”, and “consumerism”.
         Mentioned words related to online shopping, such as “e-commerce platform”, “shop around”, etc., and mentioned privacy issues in modern society.
         Explained the meaning and usage of the word “assume”, as well as related words and expressions.
         Introduced words related to the express delivery industry.
         Described the characteristics of poetry expressing emotions and the meaning and usage of some words, including expressible, inexpressible, explicable, inexplicable, call, call out, issue, recall, etc.
         Introduced words and meanings related to insurance and investment.
         Key points of choosing your lifestyle.
         Insurance in English is insurance, assurance means self-confirmation, investment in English is invest, and fund in English is fund.
         Choosing in English is to choose, and choosing your own lifestyle can be expressed as “choose their own way of life”.
         Making friends is very important, Policy is policy, Address means to solve the problem, thorny questions refer to really thorny issues.
         The lecture also emphasized the importance of independent thinking and not following the crowd, reminding young people not to be influenced by peer pressure and to choose the path that suits them.
         Introduced the meaning and usage of some English words and phrases, including headhunter, explore, fine, search, seek, find, job seeker, official, gain, benefit, formation flight, eraser, eradicate, ready, radiate, etc.
         Quoted the saying “No pain, no gain”, the correct usage is “No pain, no gain”, not “No pains, no gains”. The summary of the video “Day 3” is as follows:
         When using English, you should pay attention to using common expressions instead of using niche expressions.
         Introduced the concept of happiness in the movie “The Pursuit of Happyness”, that happiness is a process of obtaining, called The Pursuit of Happiness.
         The letter I in the word Happiness in the movie also expresses the meaning of happiness, that the answer to happiness is in oneself and needs to be found by oneself rather than looking for reasons.
         The segment ends with a line from the movie, that the answer is in oneself, “It is an eye in happiness”.
         This answer is based on the video “Day 3”.)
6. Using the knowledge output module, output the replies generated by the backend learning module to the user terminal;
7. Users can rate the generated replies. The self-learning scoring module will record the rating and provide feedback to the backend learning module for optimization of replies to similar questions;
8. Users can request related learning materials based on the reply, including:
   8.1. Selecting the required learning material category, such as knowledge graphs, slides, etc.;
   8.2. Integrating the subtitles of one or more best-matched learning materials used in the reply into a complete text. Using AI large language models, generating content corresponding to the learning material category;
   8.3. Importing the content generated by AI large language models into the corresponding learning material category generator. Exporting the corresponding learning materials;
   8.4. Sending the learning materials to the user.

In a further aspect, this invention also provides an AI teaching assistant system integrated with multiple deep learning natural language understanding algorithms and Web3.0 technology. The AI teaching assistant may include the following components: question input module, backend learning module, knowledge base storage module, self-learning scoring module, and knowledge output module.

In some embodiments, the question input module collects and records questions from student users or instructions from teacher users. The format of instructions is not fixed and can include text, audio, video, and images. Text instructions will directly enter the preprocessing stage, while audio instructions will be converted into text using speech recognition. The assistant will identify and extract text information from uploaded images and send it to the preprocessing stage. Videos will be split into audio and image information for separate processing. In the preprocessing stage, the assistant will identify valid instructions and other noise information. Valid instructions will be sent back to the backend learning module.

In some embodiments, the backend learning module learns and understands the string sequences and searches for related knowledge points in the knowledge database based on the understanding. The backend learning module includes two mature deep learning natural language understanding algorithms: GPT-3 and BERT. BERT can learn instructions bidirectionally and extract keywords. It can also process multiple lines of instructions simultaneously, learn and understand the key points and functions of each line, and select the most appropriate reply. GPT-3 uses few-shot learning, consuming fewer resources to learn user instructions. GPT-3 also assigns weights to each possible reply and sends them back to the self-learning scoring module.

In some embodiments, the knowledge base storage module stores learning materials from online learning platforms or school course content. These learning materials can be in text, image, video, and other forms, especially videos from online learning platforms. These materials go through a series of cleaning and preprocessing steps, including filtering valid information, recording knowledge point keywords, marking the knowledge categories covered by images and videos, generating subtitles and marking timestamps for videos, extracting text from images, and more. All data is summarized into documents and saved into the database. Data can be stored according to knowledge categories, but a more practical method is to store it according to the uploading institution and school, ensuring that the replies users receive are related to their affiliated institution or school.

In some embodiments, the self-learning scoring module assigns weights to the replies output by the backend learning module. The module uses ensemble learning to place the results of the two language processing algorithms into several classifiers. Each classifier uses a linear model to fit instructions and replies and returns the result with the smallest mean variance. Ensemble learning summarizes the results of all classifiers and selects the most likely result to be transmitted to the text and audio output modules. Additionally, a scoring system is provided on the frontend, allowing users to rate each reply sent by the assistant. Positive or negative ratings will be sent back to the self-learning scoring module for self-optimization. Optimization includes adjusting parameter weights, re-understanding the key points of the user's questions, and regenerating more detailed replies. A record containing the user's question, the assistant's generated reply, and the user's evaluation is generated and saved in the storage module.

In some embodiments, the knowledge output module transmits the content generated by the assistant to the user. The assistant can generate replies in various forms, including text, audio, images, and videos. The text is directly transmitted back to the interaction interface. The audio is synchronously output through the text-to-speech service. In some cases, such as when users request the generation of knowledge trees or knowledge graphs, the embedded image generator generates relevant images according to user needs. The assistant can also return hyperlinks or play a video clip in a small window. This video clip can answer the user's question and is easier to understand than pure text. The video can be a recorded lecture video or an online learning platform course video.

In this example, audio, text, images, and videos can be accepted as instruction inputs. This information is preprocessed and sent to the cloud backend. Multiple deep learning natural language understanding algorithms connected to the cloud process the information into string sequences and start learning. The algorithms use attention mechanisms to extract keywords from the instructions and calculate the possibility of multiple possible replies stored in the module. These replies are learned side by side with the instructions, and a feedback mechanism allows the algorithm to understand which reply is more appropriate.

In addition to conventional text and audio replies, the present invention also generates knowledge graphs to help users systematically understand knowledge concepts.

The raw data can be from course websites or recorded videos, initially organized after being captured by crawlers. Text data is tagged, and video data is subtitle recognized and saved as documents with timestamp markings for each sentence. This data is saved as CSV files and then cleaned. Cleaning data can use methods such as information entropy or cosine distance to remove meaningless text from the document, retaining only core knowledge and relevant information. These organized documents are sent to the backend deep learning model.

When users receive feedback from the intelligent assistant, they can rate it based on their satisfaction. This rating is integrated into a JSON file along with the user's question and the machine's feedback and sent to the backend. The learning module adjusts the weight of each parameter in the generated reply based on the question and rating, and relearns and understands the user's question. New replies are generated according to the adjusted parameters and presented to the user.

The present invention integrates multiple deep learning language understanding models, using few-shot learning to reduce resource consumption, improve operating efficiency, and generate more natural sentences. Users can freely converse with the assistant, asking questions in any tone or manner. The intelligent assistant understands which part of the information is a question and which part is free conversation through natural language models and responds accordingly.

The present invention also expands the types of information carriers it can process, accepting not only text and audio but also images and videos, enhancing the practical application, task diversity, and user convenience of the intelligent assistant system. Additionally, the intelligent assistant can use these information carriers as replies. Unlike traditional intelligent assistants that typically only reply in text and some support audio replies, the invention can provide a richer user experience with images and videos.

The present invention further allows integration into more usage scenarios, not only embedding into online learning platforms as a small assistant or using a separate webpage but also applying to the virtual environment of the metaverse, interacting with users through a modeled image and providing an immersive experience.

The foregoing shows and describes the basic principle and main features of the present invention and advantages of the present invention. A person skilled in the art should understand that the present invention is not limited by the foregoing embodiments. The foregoing embodiments and the descriptions of the specification merely explain principals of the present invention. Various variations and improvements of the present invention can be made without departing from the spirit and scope of the present invention, and the variations and improvements fall within the protection scope of the present invention. The protection scope claimed by the invention shall be defined by the attached claims and equivalents thereof.

What is claimed is:

1. A deep learning-based natural language understanding method, comprising the following steps:
S1: constructing a knowledge database by first obtaining various forms of learning materials that are pre-stored or uploaded by users, cleaning and preprocessing these learning materials, and then organizing the cleaned and preprocessed materials into documents and saving them into the knowledge database;
S2: constructing a question database by preprocessing various forms of natural language information input by users, and then saving the preprocessed natural language information into the question database;
S3: learning and understanding the natural language information in the question database, searching for related knowledge points in the knowledge database based on the understood content, and selecting the best-matched learning materials corresponding to the knowledge points as samples to respond to the natural language information using one or more scoring or matching algorithms;
S4: generating a record including the question, the response, and the evaluation, and saving it into the knowledge database; and
S5: generating multiple forms of responses and outputting them according to the corresponding requirements.

2. The deep learning-based natural language understanding method of claim 1, wherein each of the learning materials, user input natural language information, and responses is optionally in the form of text, voice, video, or image; and the cleaning and preprocessing of learning materials in step S1 comprises
(a) filtering valid information: identifying and removing invalid, redundant, or irrelevant information from the learning materials, retaining only information that contributes to understanding the text content;
(b) recording and understanding knowledge points: recording and understanding several knowledge points and their internal relationships within the learning materials;
(c) marking knowledge categories: analyzing the content of learning materials to identify and mark the knowledge categories the leaning materials cover;
(d) preprocessing video and voice learning materials: generating subtitles for video and voice learning materials and preprocessing subtitle content, which comprise semantic-based segmentation, timestamp marking, and speaker identification;
(e) preprocessing image learning materials: identifying and extracting important information from images, which comprises text within images, object features, visual elements, and various parameters; converting the information into text descriptions; and further understanding and processing the text descriptions;
(f) standardizing processing: standardizing the learning materials to reduce data noise, which comprises converting English characters to lowercase, converting Chinese characters to simplified, and removing special symbols;
(g) removing noise information: identifying and removing other noise information from the learning materials, which comprises grammatical errors, typos, and irrelevant words.

3. The deep learning-based natural language understanding method of claim 1, wherein the preprocessing of natural language information in step S2 comprises:
a. marking the categories of natural language information: analyzing the content of user input natural language information to identify and mark the knowledge categories the natural language information covers;
b. preprocessing video and voice natural language information: generating subtitles for video and voice natural language information and preprocessing subtitle content, which comprises semantic-based segmentation, timestamp marking, and speaker identification;
c. preprocessing image natural language information: identifying and extracting important information from images, which comprises text within images, object features, visual elements, and various parameters; converting the information into text descriptions; and further understanding and processing the text descriptions;
d. standardizing processing: standardizing the text information generated from natural language information to reduce data noise, which comprise converting English characters to lowercase, converting Chinese characters to simplified, and removing special symbols;
e. removing noise information: identifying and removing other noise information from natural language information, which comprises grammatical errors, typos, and irrelevant words.

4. The deep learning-based natural language understanding method of claim 1, wherein the learning and understanding of natural language information in the question database in step S3 includes comprises:
f. extracting key points: using AI large language models to learn and extract several key points from the natural language information;
g. understanding key points: using natural language processing models to understand and record each key point.

5. The deep learning-based natural language understanding method of claim 1, wherein the selection of the best-matched learning materials corresponding to the knowledge points to respond to natural language information in step S3 comprises:
h. searching for related learning materials: comparing the key points in the natural language information with each knowledge point in the knowledge database, and finding several knowledge points that are closest to the key points in the vector space;
i. selecting the best-matched learning materials: comparing the selected learning materials with the key points in the natural language information and choosing the best-matched learning materials;
j. responding using learning materials: using the selected best-matched learning materials combined with the trained AI large language model to respond to the natural language information.

6. The deep learning-based natural language understanding method of claim 1, wherein step S4 further includes a self-learning scoring process, which comprises:
k. collecting and recording user feedback on responses, including positive and negative feedback;
l. scoring the responses based on the collected feedback using certain scoring rules;
m. using the scoring results for response optimization, which comprises adjusting parameter weights, re-understanding the key points of instruction questions, and regenerating more detailed and accurate responses.

7. The deep learning-based natural language understanding method of claim 1, wherein the responses in step S5 comprises the following forms:
n. if the response is in the form of text, the response is directly output to the terminal;
o. if the response is in the form of voice, the response is converted using a text-to-speech function and synchronously output as audio;
p. if the response is learning materials, optionally including knowledge graphs or slides, the response is generated and output as relevant materials using an embedded image generator based on the requirements;
q. if the response is a video, a video link is provided or the video is played in a small window.

8. An AI teaching assistant system, comprising a cloud backend and a user terminal, wherein the user terminal collects various instruction questions input by the user and the evaluation information on the responses, and transmits them to the cloud backend; the cloud backend processes the instruction questions using the deep learning-based natural language understanding method according to claim 1, and feeds back the response information to the user terminal; and the user chooses whether to evaluate the responses and provide evaluation content via the terminal based on the received response information.

9. The AI teaching assistant system of claim 8, wherein the cloud backend comprises a knowledge base storage module, a question input module, a backend learning module, a self-learning scoring module, and a knowledge output module, wherein:
r. the knowledge base storage module is used to store the knowledge database;
s. the question input module is used to receive natural language information, which comprises text, voice, video, and image, sent from the user terminal, and preprocess the received natural language information;
t. the backend learning module is used to learn and understand the natural language information input by the user and generate multiple forms of responses;
u. the self-learning scoring module is used to assign weights to the backend learning module and optimize the backend learning module and its responses;
v. the knowledge output module is used to output the responses generated by the backend learning module to the user terminal.

10. The AI teaching assistant system of claim 8, wherein the user terminal is a hardware carrier with a user interaction interface and multiple forms of response output modules.

11. The AI teaching assistant system of claim 8, wherein the user terminal supports users in uploading learning materials in various forms comprising text, voice, video, and image, which are stored into the knowledge database by the cloud backend through the knowledge base storage module.

12. A computer storage medium, comprising a computer storage medium which stores several computer instructions, wherein the computer instructions, when invoked, execute all or part of the steps of the deep learning-based natural language understanding method according to claim 1.
